(19) United States
(12) Patent Application Publication
(10) Pub. No.: US 2020/0090225 A1
(43) Pub. Date: Mar. 19, 2020

(54) INFORMATION PROCESSING SYSTEM, INFORMATION PROCESSING APPARATUS AND VEHICLE-DIRECTED ADVERTISEMENT INFORMATION DISTRIBUTION METHOD

(71) Applicant: TOYOTA JIDOSHA KABUSHIKI KAISHA, Toyota-shi (JP)

(72) Inventors: Masatoshi HAYASHI, Nisshin-shi (JP); Shugen YAMAMURA, Nagoya-shi (JP); Hiroto INOUE, Nagakute-shi (JP); Kosuke YOSHIDA, Nagakute-shi (JP); Yoshino YAMAMORI, Nagoya-shi (JP)

(73) Assignee: TOYOTA JIDOSHA KABUSHIKI KAISHA, Toyota-shi (JP)

(21) Appl. No.: 16/560,096

(22) Filed: Sep. 4, 2019

(30) Foreign Application Priority Data
Sep. 14, 2018 (JP) 2018-172128

(51) Int. Cl. G06Q 30/02; G07C 5/00

(52) U.S. Cl. CPC G06Q 30/0266; G07C 5/008

(57) ABSTRACT

An information processing system including a vehicle and a server is provided. The vehicle includes a display installed so as to face the inside of the vehicle, a position information acquirer configured to acquire position information, and, an in-vehicle apparatus. The server includes a communicator configured to receive the position information of the vehicle and a controller configured to transmit advertisement data including a content posted on a sign present in a predetermined range centered on the vehicle in a direction in which the display is installed to the in-vehicle apparatus via the communicator. Also, the in-vehicle apparatus includes a communicator configured to transmit the position information of the vehicle to the server and receive the advertisement data from the server, and a controller configured to perform processing for causing the advertisement data to be displayed on the display.

### CROSS REFERENCE TO RELATED APPLICATION

This application claims the benefit of Japanese Patent Application No. 2018-172128, filed on Sep. 14, 2018, which is hereby incorporated by reference herein in its entirety.

### BACKGROUND

### Technical Field

The present invention relates to an information processing system for distributing advertisement information to a vehicle, an information processing apparatus and a vehicle-directed advertisement information distribution method.

### Description of the Related Art

Information provision systems in which a base station-side communication apparatus provided in a sign transmits information on a shop posted on the sign and a mobile terminal mounted in a vehicle receives the information transmitted from the base station-side communication apparatus and causes the information to be displayed on a display are disclosed (for example, in patent document 1).

### CITATION LIST

### Patent Document

[Patent document 1] Japanese Patent Laid-Open No. 2003-069512

However, the information received by the mobile terminal is information relating to the shop posted on the sign, which is not information posted on the sign itself, and thus whether or not a user of the mobile terminal views the sign itself is uncertain. Also, depending on the moving speed of the vehicle, it may be hard to see the sign itself from the vehicle window. Therefore, the conventional technique can hardly be regarded as enhancing the advertising effectiveness of the sign itself.

An object of an aspect of the disclosure is to provide an information processing apparatus that enables enhancement in advertising effectiveness of a signboard.

### SUMMARY

An aspect of the present invention provides an information processing system including a vehicle and a server, wherein

the vehicle including

a display installed so as to face an inside of the vehicle,

a position information acquirer configured to acquire position information of the vehicle, and

an in-vehicle apparatus; and

a server including

a communicator configured to receive the position information of the vehicle, and

a controller configured to transmit advertisement data including a content posted on a sign present within a predetermined range centered on the vehicle in a direction in which the display is installed, the predetermined range being identified based on the position information of the vehicle and map information, to the in-vehicle apparatus via the communicator,

wherein the in-vehicle apparatus includes

a communicator configured to transmit the position information of the vehicle to the server and receive the advertisement data from the server, and

a controller configured to perform processing for causing the advertisement data to be displayed on the display.

Another aspect of the present invention provides an information processing apparatus including:

a communicator configured to receive position information of a vehicle in which a display is installed so as to face an inside of the vehicle, from an in-vehicle apparatus included in the vehicle, the in-vehicle apparatus being configured to perform processing for display on the display; and

a controller configured to transmit advertisement data including a content posted on a sign present within a predetermined range centered on the vehicle in a direction in which the display is installed, the predetermined range being identified based on the position information of the vehicle and map information, to the in-vehicle apparatus via the communicator.

Another aspect of the present invention provides a vehicle-directed advertisement information distribution method, the method including:

receiving position information of a vehicle in which a display is installed so as to face an inside of the vehicle, from an in-vehicle apparatus included in the vehicle, the in-vehicle apparatus being configured to perform processing for display on the display; and

transmitting advertisement data including a content posted on a sign present within a predetermined range centered on the vehicle in a direction in which the display is installed, the predetermined range being identified based on the position information of the vehicle and map information, to the in-vehicle apparatus via the communicator.

The present invention enables enhancement in advertising effectiveness of a sign.

### BRIEF DESCRIPTION OF DRAWINGS

FIG. 1 is a diagram illustrating an example of a system configuration of a vehicle-directed advertisement distribution system according to a first embodiment;

FIG. 2 is a diagram illustrating an example of a hardware configuration of the center server;

FIG. 3 is a diagram illustrating a functional configuration of the center server according to the first embodiment;

FIG. 4 is a diagram illustrating an example of data stored in the sign information DB;

FIG. 5 is a diagram illustrating an example of data stored in the vehicle information DB;

FIG. 6 is a diagram illustrating an example of a hardware configuration of a vehicle;

FIG. 7 is a diagram illustrating an example of a functional configuration of the data communication apparatus according to the first embodiment;

FIG. 8 is an example of a flowchart of vehicle-directed sign information distribution processing in the center server according to the first embodiment;

FIG. 9 is a diagram illustrating an example of distribution of sign information upon movement of a vehicle in the vehicle-directed advertisement distribution system;

FIG. 10 is a diagram illustrating a system configuration of a vehicle-directed advertisement distribution system according to the second embodiment; and

FIG. 11 is an example of a flowchart of vehicle-directed sign information distribution processing in the center server according to the second embodiment.

### DESCRIPTION OF THE EMBODIMENTS

An aspect of the present invention provides an information processing system including a vehicle and a server. The vehicle includes a display installed so as to face an inside of the vehicle, a position information acquirer configured to acquire position information of the vehicle, and an in-vehicle apparatus. The server includes a communicator configured to receive the position information of the vehicle, and a controller configured to transmit advertisement data including a content posted on a sign present within a predetermined range centered on the vehicle in a direction in which the display is installed, the predetermined range being identified based on the position information of the vehicle and map information, to the in-vehicle apparatus via the communicator. The in-vehicle apparatus includes a communicator configured to transmit the position information of the vehicle to the server and receive the advertisement data from the server, and a controller configured to perform processing for causing the advertisement data to be displayed on the display.

According to the aspect of the present invention, the content of the sign present in the direction of the display in the vehicle is displayed on the display, and thus, for example, even if the display is installed in the vehicle window itself or in the vicinity of the vehicle window and the sign is hard to view from the vehicle window, an occupant of the vehicle is more likely to view the content posted on the sign, enabling enhancement in advertising effectiveness of the sign.

In the aspect of the present invention, the controller of the server may calculate the predetermined range centered on the vehicle in the direction in which the display is installed, in a predetermined period, based on the position information of the vehicle and the map information and identify the sign present within the predetermined range. For example, the predetermined range centered on the vehicle in the direction in which the display is installed changes as a result of movement of the vehicle, and along with the change, the sign present within the predetermined range switches and the advertisement data displayed on the display also switches. Consequently, it is possible to attract attention of an occupant of the vehicle to the advertisement data displayed on the display.

In the aspect of the present invention, the vehicle may include a plurality of displays installed so as to face the inside of the vehicle. Also, the in-vehicle apparatus may further include a second communicator configured to perform predetermined short-distance wireless communication. In this case, if a signal of the predetermined short-distance wireless communication, the signal including identification information of a first sign, is received by the second communicator, the controller of the in-vehicle apparatus may transmit the identification information of the first sign to the server. If the identification information of the first sign is received from the in-vehicle apparatus, the controller of the server may identify a positional relationship between the vehicle present within a range in which the in-vehicle apparatus can perform the short-distance wireless communication as the predetermined range and the first sign, identify a first display configured to display advertisement data including a content posted on the first sign from among the plurality of displays in the vehicle, and transmit information on the first display and the advertisement data including the content posted on the first sign to the in-vehicle apparatus.

For example, the first sign from which the second communicator of the in-vehicle apparatus receives a signal including identification information switches as a result of movement of the vehicle and the advertisement data displayed on the display of the vehicle also switches. Consequently, it is possible to attract attention of an occupant of the vehicle to the advertisement data displayed on the display.

Hereinafter, an embodiment of the present disclosure will be described with reference to the drawings. The configuration of the following embodiment is merely an example, and the present disclosure is not limited to the configuration of the embodiment.

### First Embodiment

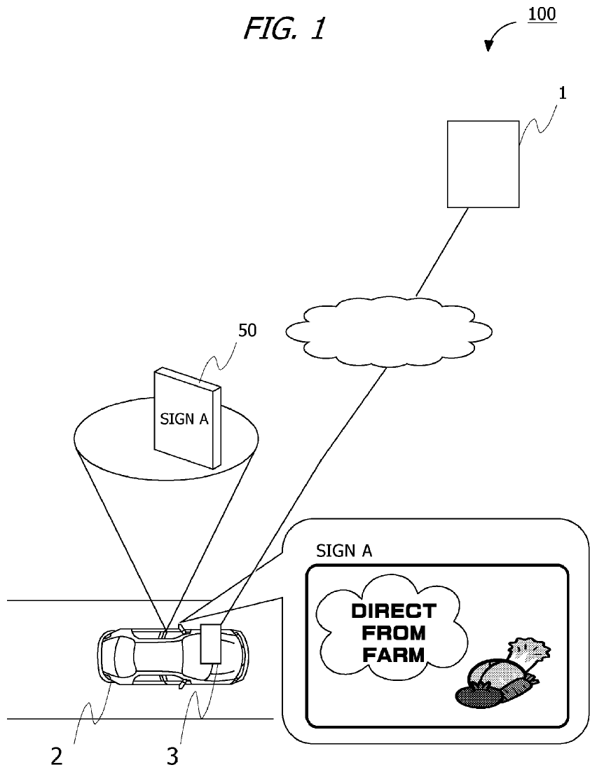

FIG. 1 is a diagram illustrating an example of a system configuration of a vehicle-directed advertisement distribution system 100 according to a first embodiment. The vehicle-directed advertisement distribution system 100 is, for example, a system that provides a service that distributes advertisement data of any of signs included in a field of view from a vehicle window to a vehicle and causes the advertisement data to be displayed on a display installed in the vicinity of the vehicle window.

The vehicle-directed advertisement distribution system 100 includes, for example, a center server 1, a plurality of vehicles 2 and a plurality of signs 50. In FIG. 1, for simplicity of illustration, one vehicle 2 and one sign are extracted and illustrated. The vehicle 2 and the sign 50 are, for example, a vehicle and a sign owned by respective users registered in the service of the vehicle-directed advertisement distribution system 100. Examples of the sign 50 include all kinds of signs such as a standing sign, a sign installed on, e.g., a roof of a building and a sign installed on a power pole. Also, the sign 50 may be an analog sign or digital signage.

In the vehicle 2, for example, a display is installed so as to face the interior space, for each of vehicle windows on the right and left sides. The display may be a standalone display apparatus including a liquid-crystal screen or may be a vehicle window with, e.g., a transparent organic EL incorporated therein.

The vehicle 2 includes a data communication apparatus 3 mounted therein. The data communication apparatus 3 is, for example, an apparatus having a function that connects to a mobile communication network such as LTE (Long-Term Evolution) or LTE-Advanced or a wireless communication network such as WiFi and communicates with the center server 1. Also, the data communication apparatus 3 is connected to the respective displays installed inside the vehicle 2 and performs display control of the displays.

In the first embodiment, the data communication apparatus 3 transmits a sign information acquisition request for requesting content data of a sign to be displayed on the displays installed inside the vehicle 2, to the center server 1 in a predetermined period. Together with the sign information acquisition request, identification information, position information and a travel direction of the vehicle 2 are transmitted to the center server 1. Upon reception of the sign information acquisition request, the center server 1 identifies a range of view from each of the vehicle windows on the right and left sides of the vehicle 2 based on the position information and the travel direction of the vehicle 2 and identifies a sign 50 present within the range. The range of view from each of the vehicle windows indicates a geographical range of view of an occupant. The sign 50 present within the range of view from a vehicle window is not limited to one that an occupant actually can see from the vehicle window and examples of the sign 50 include a sign 50 that an occupant is unable to see because of the sign 50 being blocked by a building but is included in a geographical range of the occupant's field of view from the vehicle window. The range of view from a vehicle window is an example of “predetermined range centered on the vehicle in a direction in which the display is installed”.

The center server 1 transmits content data corresponding to a content posted on the identified sign 50 to the data communication apparatus 3. The content data is, for example, image data, moving image data, image data and sound data, or, moving image data and sound data of the sign 50. Together with the content data, information for designating a display to display the content data is transmitted. The content data of the sign 50 is an example of “advertisement data”.

The data communication apparatus 3 causes the received content data of the sign 50 to be displayed on the designated display on the relevant vehicle window. Consequently, an occupant in the vehicle 2 can more easily view the sign present within the field of view from the vehicle window, enabling enhancement in advertising effectiveness of the sign 50.

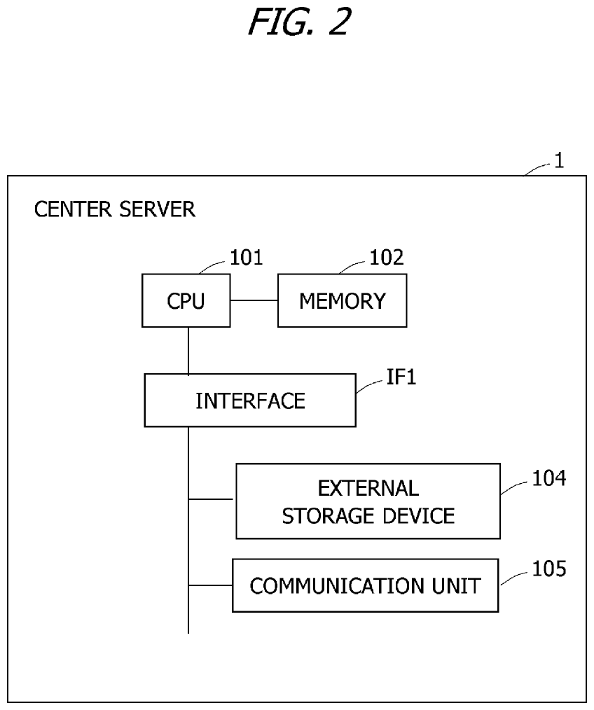

FIG. 2 is a diagram illustrating an example of a hardware configuration of the center server 1. The center server 1 is, for example, a special-purpose computer or a general-purpose computer. The center server 1 includes a CPU (Central Processing Unit) 101, a memory 102, an interface IF1, an external storage device 104 and a communication unit 105 as the hardware configuration. Each of the memory 102 and the external storage device 104 is a computer-readable recording medium. The center server 1 is an example of “server” or “information processing apparatus”.

The interface IF1 connects the CPU 101, and the external storage device 104 and the communication unit 105. The external storage device 104 stores various programs and data that the CPU 101 uses in executing the respective programs. The external storage device 104 is, for example, an EPROM (erasable programmable ROM) or a hard disk drive. Examples of the programs held in the external storage device 104 include an operating system (OS), an advertisement distribution control program and various other application programs. The advertisement distribution control program is a program for controlling distribution of content data of a sign included within a predetermined range from a vehicle window of the vehicle 2 to the data communication apparatus 3 mounted in the vehicle 2. The advertisement distribution control program is an example of “information processing program”.

The memory 102 is a main memory that provides a memory area and a work area for the CPU 101 to load a program stored in the external storage device 104 and is used as a buffer. The memory 102 includes, for example, a semiconductor memory such as a ROM (read-only memory) or a RAM (random access memory).

The CPU 101 performs various types of processing by loading the OS and various application programs held in the external storage device 104 to the memory 102 and executing the OS and various application programs. The number of CPUs 101 is not limited to one and a plurality of CPUs 101 may be provided. The CPU 101 is an example of “controller” of “server” or “information processing apparatus”.

The communication unit 105 is an interface via which information are input/output from/to a network. The communication unit 105 may be an interface that connects to a wired network or an interface that connects to a wireless network. Examples of the communication unit 105 include, e.g., an NIC (network interface card) or a wireless circuit. The communication unit 105 is an example of “communicator” of “server” or “information processing apparatus”.

Note that the hardware configuration of the center server 1 illustrated in FIG. 2 is a mere example and is not limited to the example and appropriate omission, replacement and addition of components are possible according to the embodiment. For example, the center server 1 may include a removable recording medium drive device and execute a program recorded in a removable recording medium. The removable recording medium is, for example, a recording medium such as an SD card, a mini SD card, a micro SD card, a USB (universal serial bus) flash memory, a CD (compact disc), a DVD (digital versatile disc), a Blu-ray (registered trademark) disc or a flash memory card. Also, for example, the center server 1 may include an input device and an output device. Examples of the input device include, e.g., a keyboard, a mouse and a touch panel. Examples of the output device include, e.g., a display.

Note that a series of processing performed in the center server 1 can be implemented not just by execution of software by the processor 101 but also by, for example, hardware such as an FPGA (field-programmable gate array).

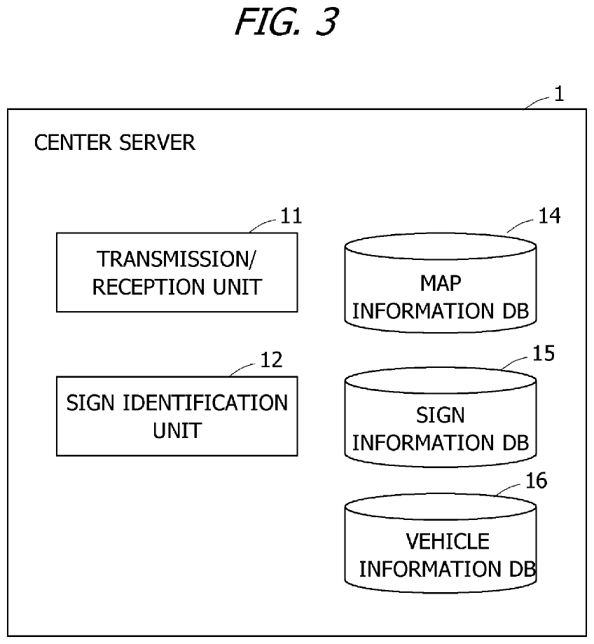

FIG. 3 is a diagram illustrating a functional configuration of the center server 1 according to the first embodiment. The center server 1 includes a transmission/reception unit 11, a sign identification unit 12, a map information database (DB) 14, a sign information DB 15 and a vehicle information DB 16 as functional components. Each of these functional components are functional components implemented by execution of the advertisement distribution control program by the CPU 101 of the center server 1.

The transmission/reception unit 11 is an interface with the data communication apparatus 3 and performs data transmission/reception to/from the data communication apparatus 3. In the first embodiment, for example, the transmission/reception unit 11 receives a sign information acquisition request from the data communication apparatus 3. The sign information acquisition request received from the data communication apparatus 3 is output to the sign identification unit 12. Also, for example, upon reception of an input of sign information from the sign identification unit 12, the transmission/reception unit 13 transmits the sign information to the data communication apparatus 3.

The sign identification unit 12 receives an input of the sign information acquisition request from the data communication apparatus 3, from the transmission/reception unit 11. Together with the sign information acquisition request, for example, the identification information, the position information and the travel direction of the vehicle 2 in which the data communication apparatus 3 is mounted are received.

The sign identification unit 12 acquires vehicle information matching the identification information of the vehicle 2 from the later-described vehicle information DB. The vehicle information of the vehicle 2 includes, e.g., identification information and a position of each vehicle windows of the vehicle 2. The sign identification unit 12 identifies a range of view for each vehicle window of the vehicle 2, based on the position information of the vehicle 2 and the later-described map information DB 14.

A range of view from a vehicle window is calculated, for example, as follows. First, the sign identification unit 12 identifies a position and a direction of the vehicle 2 on a map, based on the map information DB 14 and the position information and the travel direction of the vehicle 2. Next, the sign identification unit 12 identifies a direction in which a vehicle window is present, the direction being orthogonal to the travel direction of the vehicle 2, as a direction of a field of view from the vehicle window. The sign identification unit 12 identifies a fan-like range centered on the position of the vehicle 2, the range facing the direction of the field of view from the vehicle window and having a predetermined center angle and a predetermined radius as a range of view from the vehicle window on a map. The center angle of the fan shape forming the range of view from the vehicle window may be determined in advance, for example, from a distance between the eyes of a human being when seated and the vehicle window and a width of the vehicle window. The radius of the fan shape forming the range of view from the vehicle window may be, for example, set in advance by an administrator of the vehicle-directed advertisement distribution system 100 or may be set for each region according to the characteristic of the region in which the vehicle 2 is currently located. Note that the method for identifying a range of view from a vehicle window is not limited to this example and any known identification method may be used.

The sign identification unit 12 identifies a sign 50 present within the range of view for each vehicle window of the vehicle 2. For example, a position of each sign 50 is plotted on a map stored in the map information DB 14, and the sign identification unit 12 acquires identification information of a sign 50 plotted within the range of view from the vehicle window on the map.

The sign identification unit 12 acquires content data of the sign 50 present within the identified range of view from each vehicle window from a later-described sign information DB 15, associates the identification information of the vehicle window and the acquired content data of the sign 50 with each other and outputs the association to the transmission/reception unit 11. The association between the identification information of each vehicle window and the content data of the sign 50 is transmitted from the transmission/reception unit 11 to the data communication apparatus 3, which is a transmission source of the sign information acquisition request, as a response to the sign information acquisition request. Note that for each vehicle window, the sign identification unit 12 may determine a sign 50, content of which is to be displayed on the display, or, for example, processing may be performed collectively for a plurality of vehicle windows installed on a same side of the vehicle 2.

The map information DB 14, the sign information DB 15 and the vehicle information DB 16 are created, for example, inside the external storage device 104 of the center server 1. The map information DB 14 stores map information. In the map information, for example, positions of signs 50 are plotted and each plot is associated with identification information of the relevant sign 50.

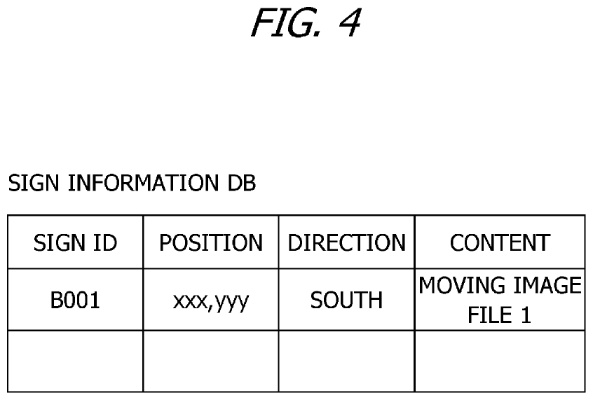

FIG. 4 is a diagram illustrating an example of data stored in the sign information DB 15. In the sign information DB 15, sign information pieces relating to signs 50 registered in the service of the vehicle-directed advertisement distribution system 100 are stored. For each sign 50, for example, the sign information DB 15 includes fields of sign ID, position, direction, and content as sign information pieces of the sign 50. In the sign ID field, identification information of the sign 50 is stored. The identification information of the sign 50 is, for example, information for uniquely identifying the sign 50 in the vehicle-directed advertisement distribution system 100, the information being provided by the administrator of the vehicle-directed advertisement distribution system 100.

In the position field, position information of a position at which the sign 50 is installed is stored. The position information of the sign 50 may be, for example, either a latitude and a longitude or an address. In the direction field, a direction the sign 50 faces is stored. In the content field, for example, a position at which a file of an image, a moving image and/or sound posted on the sign 50 is stored in the center server 1 is stored.

Values of the respective sign ID, position, direction and content fields are registered in advance by the administrator of the vehicle-directed advertisement distribution system 100. Note that the information stored in the sign information DB 15 is not limited to the information indicated in FIG. 4.

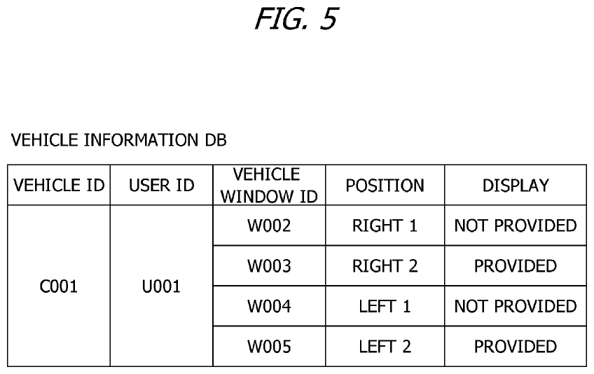

FIG. 5 is a diagram illustrating an example of data stored in the vehicle information DB 16. The vehicle information DB 16 stores vehicle information pieces relating to vehicles 2 registered in the service of the vehicle-directed advertisement distribution system 100. For each vehicle 2, for example, the vehicle information DB 16 includes fields such as vehicle ID, user ID, vehicle window ID, position and display as vehicle information pieces of the vehicle 2.

In the vehicle ID field, identification information of the vehicle 2 is stored. The identification information of the vehicle 2 is, for example, either identification information provided by the administrator of the vehicle-directed advertisement distribution system 100 or a vehicle identification number of the vehicle 2. In the user ID field, identification information of a user that registered the vehicle 2 is stored. The identification information of the user is, for example, either identification information provided by the administrator of the vehicle-directed advertisement distribution system 100 or identification information provided by the user itself.

For each of vehicle window ID, position and display, a number of fields, the number corresponding to the number of vehicle windows installed on the right and left sides of the vehicle 2, are provided. In each vehicle window ID field, identification information of a relevant vehicle window is stored. Identification information pieces of vehicle windows just need to be capable of uniquely identifying the respective vehicle windows in the vehicle 2 and may be overlapped with those of another vehicle 2. The identification information pieces of the vehicle windows are, for example, provided by the administrator of the vehicle-directed advertisement distribution system 100 and shared with the data communication apparatus 3 mounted in the vehicle 2.

In each position field, a position at which a relevant vehicle window is installed is stored. For example, in the position fields, values of, e.g., right 1, right 2, . . . , left 1, each of which is a combination of the right or the left of the vehicle 2 and the order from the front, are stored, respectively. In each display field, information indicating whether or not the relevant vehicle window itself is a display or a display is installed in the vicinity of the relevant vehicle window is stored. For example, in each display field, either “provided” or “not provided” is stored.

Information stored in the vehicle information DB 16 is, for example, input by the administrator of the vehicle-directed advertisement distribution system 100 according to a report from the user of the vehicle 2 or input through reception from a user terminal of the user of the vehicle 2. Note that the information stored in the vehicle information DB 16 is not limited to the information indicated in FIG. 5.

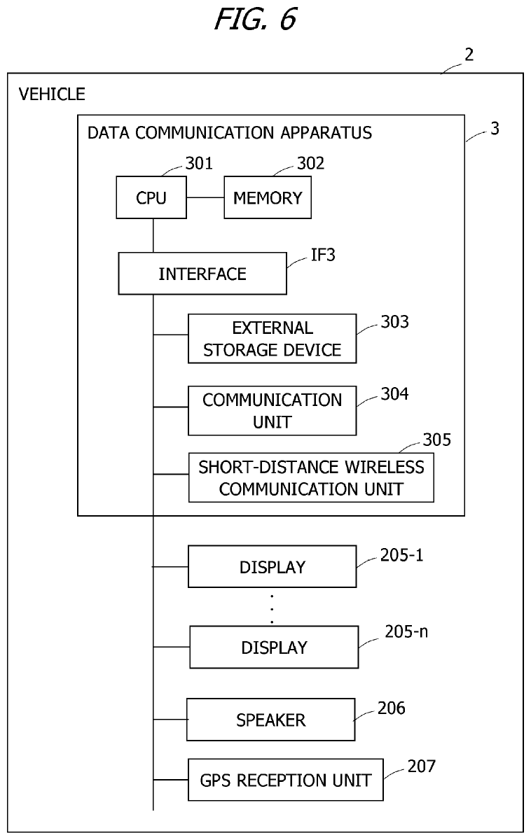

FIG. 6 is a diagram illustrating an example of a hardware configuration of a vehicle 2. The vehicle 2 includes a data communication apparatus 3, a plurality of displays 205, a speaker and a GPS reception unit 207 as the hardware configuration. However, in FIG. 6, a configuration relating to enjoying the service of the vehicle-directed advertisement distribution system 100 is extracted and illustrated, and hardware configuration components included in the vehicle 2 are not limited to those illustrated in FIG. 6. The vehicle 2 is an example of “vehicle”.

The data communication apparatus 3 includes a CPU 301, a memory 302 and an interface IF3. An external storage device 303, a communication unit 304, a short-distance wireless communication unit 305, the displays 205, the speaker 206 and the GPS reception unit 207 are connected to the interface IF3. The data communication apparatus 3 is an example of “in-vehicle apparatus”.

The communication unit 304 is, for example, a communication unit for communication with, e.g., various servers on a network through a mobile phone base station and a public communication channel network connected to the mobile phone base station. The communication unit 304 performs wireless communication, for example, using a radio signal and a wireless communication method according to a predetermined wireless communication standard such as LTE or LTE-Advanced. The communication unit 304 is an example of “communicator” of “in-vehicle apparatus”.

The short-distance wireless communication unit 305 performs wireless communication, for example, using a radio signal and a wireless communication method according to a predetermined short-distance wireless communication standard such as BLUETOOTH (registered trademark), BLE (Bluetooth Low Energy) or WiFi Direct. The short-distance wireless communication unit 305 is an example of “second communicator”.

Each of the displays 205 is provided in the relevant vehicle window itself or in the vicinity of the relevant vehicle window. The displays 205 are provided, for example, at the front and rear, right and left vehicle windows in the vehicle 2, respectively. Although in FIG. 6, displays 205-1, 205-2, . . . provided at the respective front and rear, right and left vehicle windows in the vehicle 2 are illustrated, and where the displays 205-1, 205-2, . . . are not specifically distinguished from one another, each of the displays 205-1, 205-2, . . . is indicated as “display 205”. Each display 205 is an example of “display”.

The Global Positioning System (GPS) reception unit 207 receives radio waves of a time signal from a plurality of artificial satellites orbiting the earth (global positioning satellites) and acquires position information based on the time signal. The speaker 206 reproduces and outputs sound and/or voice. The GPS reception unit 207 is an example of “position information acquirer”.

The CPU 301, the memory 302 and the external storage device 303 of the data communication apparatus 3 are similar to the CPU 101, the memory 102 and the external storage device 104 of the center server 1. In other words, the CPU 301 executes a computer program loaded so as to be executable in the memory 302 to perform processing as the data communication apparatus 3. The memory 302 stores, e.g., a computer program to be executed by the CPU 301 and data to be processed by the CPU 301. The external storage device 303 is a non-volatile memory device, and, for example, a solid-state drive (SSD) or a hard disk drive. In the external storage device 303, for example, a client application for enjoying the service of the vehicle-directed advertisement distribution system 100 is stored. The CPU 301 of the data communication apparatus 3 is an example of “controller” of “in-vehicle apparatus”.

The data communication apparatus 3 causes each display 205 to display an image, characters and/or other information. Although in FIG. 6, the interface IF3 is illustrated, provision/reception of signals between the data communication apparatus 3 and peripheral hardware components is not limited to provision/reception via the interface IF3. In other words, the data communication apparatus 3 may include a plurality of signal provision/reception pathways other than the interface IF3. Also, in FIG. 6, the data communication apparatus 3 includes a single CPU 301. However, the CPU is not limited to a single processor and may have a multi-processor configuration. Also, a single CPU connected to a single socket may have a multi-core configuration. At least a part of the processing in any of the respective units may be performed by a processor other than the CPU, for example, a special-purpose processor such as a digital signal processor (DSP) or a graphics processing unit (GPU). Also, at least a part of the processing in any of the respective units may be an integrated circuit (IC) or another digital circuit. Also, at least part of any of the respective units may include an analog circuit.

Note that although in the first embodiment, the vehicle 2 is assumed to be a vehicle that moves via manual driving, but the present invention is not limited to this example and the vehicle 2 may be a vehicle that moves via automatic driving. Where the vehicle 2 is a vehicle that moves via automatic driving and a display is installed on each of front and rear, right and left sides of the vehicle, a sign 50, content data of which is to be displayed on the relevant display, may be identified for each side.

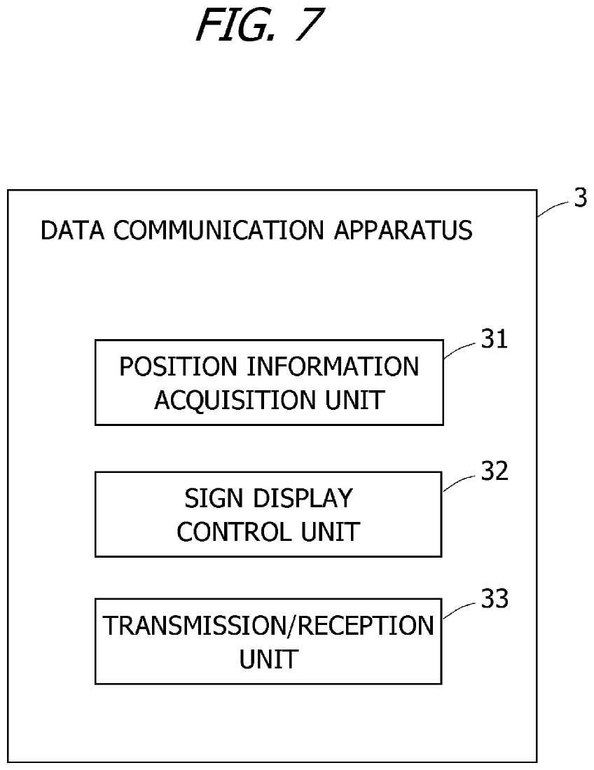

FIG. 7 is a diagram illustrating an example of a functional configuration of the data communication apparatus 3 according to the first embodiment. The data communication apparatus 3 includes a position information acquisition unit 31, a sign display control unit 32 and a transmission/reception unit 33 as functional components. These functional components are implemented by, for example, execution of a client application for enjoying the service of the vehicle-directed advertisement distribution system 100 by the CPU 301 of the data communication apparatus 3.

The transmission/reception unit 33, which is an interface with the center server 1, transmits/receives data to/from the center server 1. In the first embodiment, the transmission/reception unit 33 transmits a sign information acquisition request input from the sign display control unit 32 to the center server 1. Together with the sign information acquisition request, for example, the identification information, the position information and the travel direction of the vehicle 2 are transmitted to the center server 1. Also, the transmission/reception unit 33 receives the association between the identification information of each vehicle window and the content data of the relevant sign 50 as a response to the sign information acquisition request from the center server 1 and outputs the association to the sign display control unit 32. Note that one or more associations between the identification information of each vehicle window and the content data of the relevant sign 50 are received from the center server 1.

The position information acquisition unit 31 acquires, for example, position information of the vehicle 2 acquired by the GPS reception unit 207, in a predetermined period and stores the position information in the memory 302. The position information of the vehicle 2 may be, for example, any of a latitude and a longitude, an address and the like.

The sign display control unit 32 generates a sign information acquisition request in a predetermined period during the vehicle 2 moving. The period of generation of a sign information acquisition request by the sign display control unit 32 is, for example, ten seconds to one minute, and be appropriately set by the administrator of the vehicle-directed advertisement distribution system 100 or the user of the vehicle 2 registered in the service of the vehicle-directed advertisement distribution system 100.

A more specific description will be provided below. At a timing of generation of a sign information acquisition request, the sign display control unit 32 acquires the position information of the vehicle 2 from the position information acquisition unit 31. The position information acquired at this time include a plurality of position information pieces including latest position information and position information pieces of a predetermined number of times before or a predetermined period of time before. The sign display control unit 32 acquires a travel direction of the vehicle 2 based on the plurality of position information pieces acquired. The sign display control unit 32 outputs the sign information acquisition request and the identification information, the position information and the travel direction of the vehicle 2 to the transmission/reception unit 33 to transmit the sign information acquisition request and the identification information, the position information and the travel direction of the vehicle 2 to the center server 1.

Also, the sign display control unit 32 receives an input of the identification information of a vehicle window and content data of a relevant sign 50 received from the center server 1, from the transmission/reception unit 33. The sign display control unit 32 identifies a display 205 to display the input content data of the sign 50, from the input identification information of the vehicle window and causes the identified display 205 to display the input content data of the sign 50. The display 205 to display the input content data of the sign 50 is a display installed in a vehicle window corresponding to the input identification information of the vehicle window itself or in the vicinity of the vehicle window. Note that the identification information of the vehicle 2 and an association between identification information of each vehicle window and a relevant display 205 are stored in advance in, for example, a predetermined memory area of the external storage device 303.

<Flow of Processing>

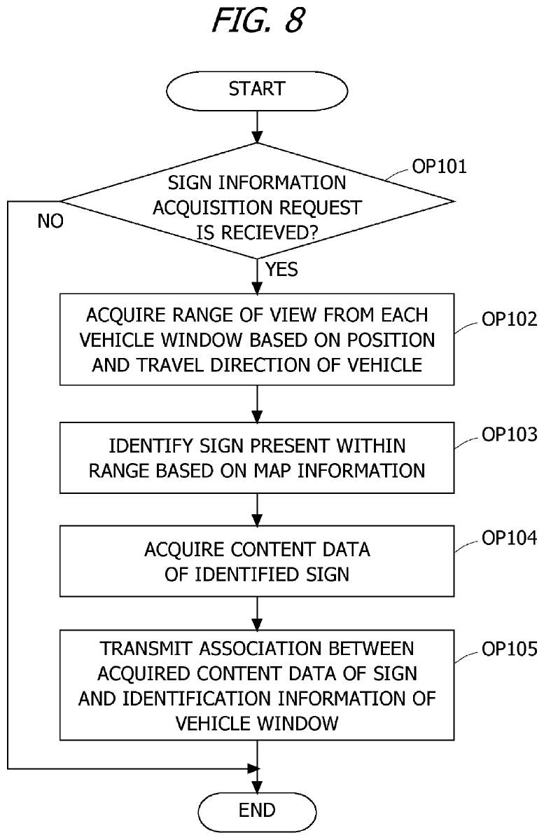

FIG. 8 is an example of a flowchart of vehicle-directed sign information distribution processing in the center server 1 according to the first embodiment. The processing illustrated in FIG. 8 is repeatedly performed, for example, in a predetermined period. Although an entity that performs the processing illustrated in FIG. 8 is the CPU 101 of the center server 1, for sake of convenience, the processing will be described with a functional component as the entity.

In OP101, the sign identification unit 12 determines whether or not a sign information acquisition request has been received from a data communication apparatus 3. If a sign information acquisition request has been received from a data communication apparatus 3 (OP101: YES), the processing proceeds to OP102. If no sign information acquisition request has been received from a data communication apparatus 3 (OP101: NO), the processing illustrated in FIG. 8 ends. In the below, it is assumed that if a data communication apparatus 3 is referred to regarding FIG. 8, the data communication apparatus 3 refers to a data communication apparatus 3 that is a transmission source of the sign information acquisition request. Also, in the below, it is assumed that if a vehicle 2 is referred to regarding FIG. 8, the vehicle 2 refers to a vehicle 2 in which the communication apparatus 3 that is a transmission source of the sign information acquisition request is mounted.

In OP102, for each of vehicle windows installed on right and left sides of the vehicle 2, the sign identification unit 12 identifies a range of view with reference to the map information DB 14, based on the position information and the travel direction of the vehicle 2 received together with the sign information acquisition request. Note that vehicle windows to be subjected to the processing in OP102 onwards is limited to vehicle windows with a display installed in the vehicle window itself or in the periphery of the vehicle window. Information on right and left-side vehicle windows installed in the vehicle 2 are acquired, for example, from the vehicle information DB 16 based on the identification information of the vehicle 2 received together with the sign information acquisition request.

In OP103, for each vehicle window, the sign identification unit 12 identifies a sign 50 present within the range of view with reference to the map information DB 14 and determines a sign 50, content data of which is to be distributed to the vehicle 2. The number of signs 50, content data of which is to be distributed to the vehicle 2, is not limited to one and there may be a plurality of signs 50, content data of which is to be distributed to the vehicle 2. The signs 50, content data of which is to be distributed to the vehicle 2, are determined, for example, based on the respective degrees of priority determined according to the amount of investment or in order of distance from or proximity to the vehicle 2. Note that if there is no sign 50 present within the range of view from the vehicle window, a notice to the effect that there is no content data to be displayed is transmitted as a response to the sign information acquisition request. Note that signs not facing the vehicle 2 may be excluded from signs 50 to be selected as signs 50, content data of which is to be distributed to the vehicle 2.

In OP104, the sign identification unit 12 acquires the content data of the sign 50, for which content data thereof has been determined to be transmitted to the vehicle 2 in OP103, from the sign information DB 15. In OP105, the sign identification unit 12 transmits an association between the acquired content data of the sign 50 and the identification information of the vehicle window to the vehicle 2. Subsequently, the processing illustrated in FIG. 8 ends.

<Operation and Effects of the First Embodiment>

According to the first embodiment, content data of a sign present on the other side of a vehicle window is displayed on a display installed in the vehicle window or in the vicinity of the vehicle window, and thus, even a sign an occupant of a vehicle 2 can hardly see because of the vehicle 2 moving can easily be viewed, enabling enhancement in advertising effectiveness of the sign. Also, an occupant of the vehicle 2 often faces toward the vehicle window side and content data of a sign 50 is displayed in a direction of line of sight of the occupant, enabling the line of sight of the occupant to be naturally led to the sign 50.

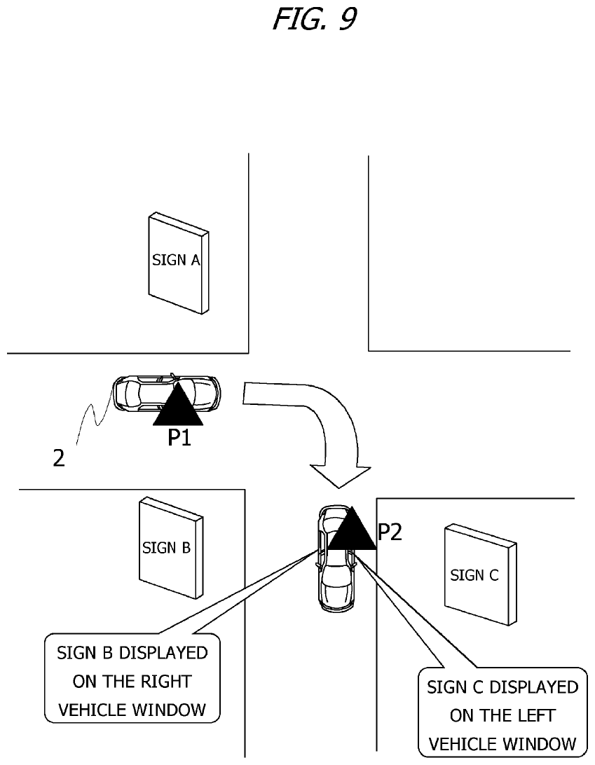

FIG. 9 is a diagram illustrating an example of distribution of sign information upon movement of a vehicle 2 in the vehicle-directed advertisement distribution system 100. At position P1 in FIG. 9, sign A is present within a range of view from a left vehicle window of the vehicle 2 and sign B is present within a range of view from a right vehicle window. Therefore, if a data communication apparatus 3 of the vehicle 2 transmits a sign information acquisition request to the center server 1 when passing through position P1, content data of sign A is displayed on a display corresponding to the left vehicle window of the vehicle 2 and content data of sign B is displayed on a display corresponding to the right vehicle window. As described above, even in a same vehicle 2, content data of a sign displayed is different depending on the direction of the vehicle window, enabling an occupant of the vehicle 2 to spend time with entertainment in the vehicle 2. Also, for example, if there is a shop that is an advertiser of a sign 50 in the vicinity of the sign 50, it is possible to suggest that the shop is present in the direction of the vehicle window or the display on which content data of the sign 50 is displayed.

Also, if the vehicle 2 has moved to position P2, the range of view from the left vehicle window of the vehicle 2 changes and a sign 50 included in the range of view thus switches to another. In FIG. 9, at position P2, in the range of view from the left vehicle window of the vehicle 2, sign C is present. Therefore, for example, if the data communication apparatus 3 of the vehicle 2 transmits a sign information acquisition request to the center server 1 when passing through position P2, content data of sign C is displayed on the display corresponding to the left vehicle window of the vehicle 2. As described above, since content data of a sign 50 displayed on a display of a vehicle window switches along with change of a range of view from a vehicle window due to movement of a vehicle 2, it is easy to attract attention of an occupant of the vehicle 2, enabling enhancement in advertising effectiveness of the sign 50.

### Second Embodiment

In a second embodiment, a sign 50 includes a transmitter for short-distance wireless communication, and if a vehicle 2 receives a signal transmitted from the sign 50, the vehicle 2 transmits a sign information acquisition request for the sign 50 to the center server 1. In the second embodiment, description that is in common with the first embodiment will be omitted.

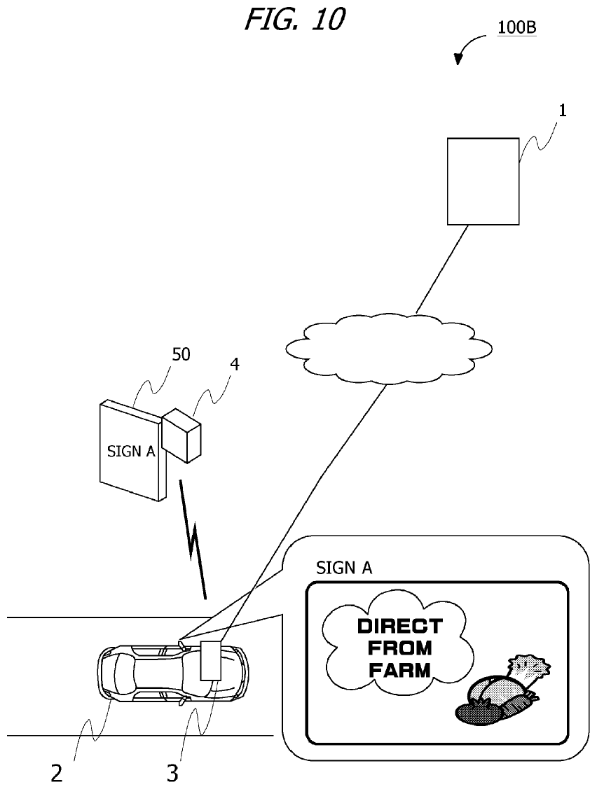

FIG. 10 is a diagram illustrating a system configuration of a vehicle-directed advertisement distribution system 100B according to the second embodiment. The advertisement distribution system 100B includes a center server 1, a vehicle 2, a data communication apparatus 3 mounted in the vehicle 2, a sign 50 and a transmitter 4 provided in the sign 50.

The transmitter 4 is, for example, a transmitter that transmits a signal according to a short-distance wireless communication standard such as BLUETOOTH (registered trademark), BLE or WiFi Direct. The signal transmitted by the transmitter 4 contains, for example, identification information of the sign 50. The transmitter 4 and a short-distance wireless communication unit 305 of the data communication apparatus 3 transmit or receive a radio signal according to the same short-distance wireless communication standard.

In the second embodiment, if the data communication apparatus 3 receives a signal transmitted from the transmitter 4 provided in the sign 50, the data communication apparatus 3 transmits a sign information acquisition request to the center server 1. At this time, together with the sign information acquisition request, identification information, position information and a travel direction of the vehicle 2 and identification information of the sign 50, the identification information of the sign 50 being included in the transmitted signal, are transmitted to the center server 1.

Upon reception of the sign information acquisition request from the data communication apparatus 3, the center server 1 identifies a positional relationship between the vehicle 2 and the sign 50 and transmits an association between content data of the sign 50 and identification information of a vehicle window corresponding to a display to display the content data of the sign 50 to the data communication apparatus 3. The data communication apparatus 3 causes the received content data of the sign 50 to be displayed on the display corresponding to the vehicle window, the identification information of which is associated with the content data.

In other words, in the second embodiment, a sign 50, content data of which is to be displayed on a display corresponding to a vehicle window, is identified using a range in which short-distance wireless communication is possible instead of a range of view from a vehicle window in the first embodiment. Note that in the second embodiment, respective hardware configurations and functional configurations of the center server 1, the vehicle 2 and the data communication apparatus 3 are similar to those in the first embodiment. A range in which short-distance wireless communication is possible from the data communication apparatus 3 is an example of “predetermined range centered on the vehicle in a direction in which the display is installed”.

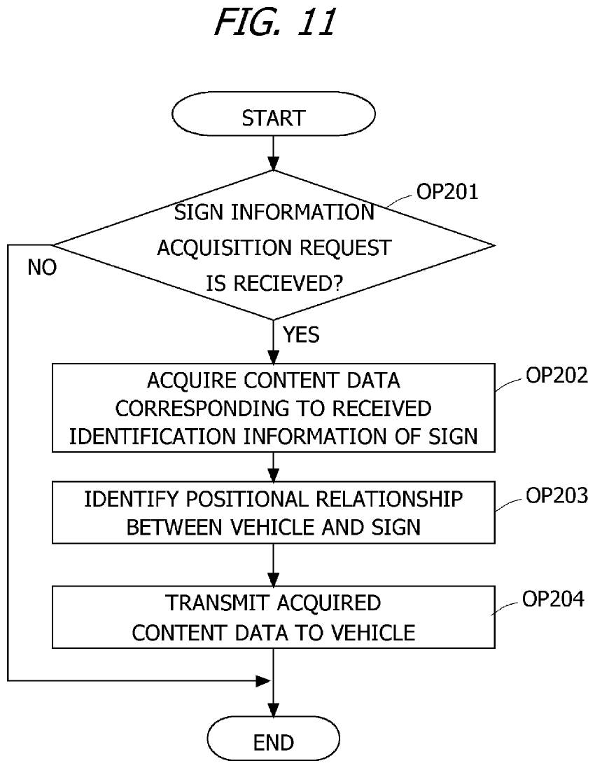

FIG. 11 is an example of a flowchart of vehicle-directed sign information distribution processing in the center server 1 according to the second embodiment. The processing illustrated in FIG. 11 is repeatedly performed, for example, in a predetermined period. Although an entity that performs the processing illustrated in FIG. 11 is a CPU 101 of the center server 1, for sake of convenience, the processing will be described with a functional component as the entity.

In OP201, a sign identification unit 12 determines whether or not a sign information acquisition request has been received from a data communication apparatus 3. If a sign information acquisition request has been received from a data communication apparatus 3 (OP201: YES), the processing proceeds to OP202. If no sign information acquisition request has been received from a data communication apparatus 3 (OP201: NO), the processing illustrated in FIG. 11 ends. In the below, it is assumed that if a data communication apparatus 3 is referred to regarding FIG. 11, the data communication apparatus 3 refers to a data communication apparatus 3 that is a transmission source of the sign information acquisition request. Also, in the below, it is assumed that if a vehicle 2 is referred to regarding FIG. 11, the vehicle 2 refers to a vehicle 2 in which the data communication apparatus 3 that is a transmission source of the sign information acquisition request is mounted.

In OP202, the sign identification unit 12 acquires content data of a sign 50 from a sign information DB 15 based on identification information of the sign 50 received together with the sign information acquisition request.

In OP203, the sign identification unit 12 identifies a positional relationship between the sign 50, the identification information of which has been received together with the sign information acquisition request, and the vehicle 2, based on a map information DB 14. The positional relationship between the sign 50 and the vehicle 2 is identified based on position information of the sign 50 and position information and a travel direction of the vehicle 2. Consequently, on which side of the right and left sides of the vehicle the sign 50 is located can be determined, enabling identification of a vehicle window corresponding to a display to display the content data of the sign 50.

In OP204, the sign identification unit 12 transmits an association between the content data of the sign 50 acquired in OP202 and the identification information of the vehicle window to display the content data of the sign 50 to the data communication apparatus 3. Subsequently, the processing illustrated in FIG. 11 ends.

Note that the vehicle-directed sign information distribution processing in the center server 1 according to the second embodiment is not limited to the processing illustrated in FIG. 11. For example, if the data communication apparatus 3 has received signals transmitted from a plurality of signs 50, the data communication apparatus 3 may transmit identification information pieces of the plurality of signs 50 to the center server 1, together with a sign information acquisition request. Also, the center server 1 receives the identification information pieces of the plurality of signs 50 together with the sign information acquisition request from the data communication apparatus 3, and content data of one or a predetermined number of signs 50 may be transmitted to the data communication apparatus 3 if the signs 50 are present in a same direction relative to the vehicle 2. At this time, a sign 50, content data of which is to be transmitted, may be determined based on, e.g., degrees of priority of the respective signs or respective distances of the signs from the vehicle 2.

According to the second embodiment, content data of a sign 50 present within a range of short-distance wireless communication and also present on the other side of a vehicle window is displayed on a display corresponding to the vehicle window, and even where the sign 50 itself is hard to see, it is possible to cause an occupant to view the content data of the sign 50, enabling enhancement in advertising effectiveness of the sign.

The embodiment described above is an example, and the present disclosure may be changed and carried out as appropriate without departing from the gist of the present disclosure.

Although in each of the first embodiment and the second embodiment, a data communication apparatus 3 transmits position information and a travel direction of the relevant vehicle 2 to the center server 1, together with a sign information acquisition request, the present invention is not limited to this example. For example, a data communication apparatus 3 may transmit position information of the relevant vehicle 2 to the center server 1 in a predetermined period and the center server 1 may monitor the position of the vehicle 2 and thereby acquire position information and a travel direction of the vehicle 2 when receiving a sign information acquisition request.

Also, although each of the first embodiment and the second embodiment has been described in terms of the case where content data of a sign 50 is displayed on a display installed in a vehicle window itself of a vehicle 2 or in the vicinity of the vehicle window, the present invention is not limited to this example. For example, content data of a sign 50 may be displayed on a display installed on a side on which no vehicle window is installed from among the front and rear, right and left sides of a vehicle 2. In this case, for each vehicle 2, the center server 1 may hold identification information pieces of respective displays and positions at which the respective displays are installed in the vehicle 2 in the vehicle information DB 16, identify a sign 50 present within a predetermined range on the outer side from each display of the vehicle 2, and transmit content data of the identified sign 50 and identification information of a display to display the content data, to the data communication apparatus 3. Also, the displays to display content data in the vehicle 2 are not limited to those on the front and rear, right and left sides of the vehicle 2 and may include those on the upper and lower sides of the vehicle 2.

The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing system comprising a vehicle and a server, wherein
the vehicle includes
a display installed so as to face an inside of the vehicle,
a position information acquirer configured to acquire position information of the vehicle, and
an in-vehicle apparatus; and
the server includes
a communicator configured to receive the position information of the vehicle, and
a controller configured to transmit advertisement data including a content posted on a sign present within a predetermined range centered on the vehicle in a direction in which the display is installed, the predetermined range being identified based on the position information of the vehicle and map information, to the in-vehicle apparatus via the communicator, and
wherein the in-vehicle apparatus includes
a communicator configured to transmit the position information of the vehicle to the server and receive the advertisement data from the server, and
a controller configured to perform processing for causing the advertisement data to be displayed on the display.

2. The information processing system according to claim 1, wherein the controller of the server is configured to calculate the predetermined range centered on the vehicle in the direction in which the display is installed, in a predetermined period, based on the position information of the vehicle and the map information and identifies the sign present within the predetermined range.

3. The information processing system according to claim 1, wherein:
the vehicle includes a plurality of displays installed so as to face the inside of the vehicle;
the in-vehicle apparatus further includes a second communicator configured to perform predetermined short-distance wireless communication;
if a signal of the predetermined short-distance wireless communication, the signal including identification information of a first sign, is received by the second communicator, the controller of the in-vehicle apparatus is configured to transmit the identification information of the first sign to the server; and
if the identification information of the first sign is received from the in-vehicle apparatus, the controller of the server is configured to
identify a positional relationship between the vehicle present within a range in which the in-vehicle apparatus can perform the short-distance wireless communication as the predetermined range and the first sign,
identify a first display configured to display advertisement data including a content posted on the first sign from among the plurality of displays in the vehicle, and
transmit information on the first display and the advertisement data including the content posted on the first sign to the in-vehicle apparatus.

4. An information processing apparatus comprising:
a communicator configured to receive position information of a vehicle in which a display is installed so as to face an inside of the vehicle, from an in-vehicle apparatus included in the vehicle, the in-vehicle apparatus being configured to perform processing for display on the display; and
a controller configured to transmit advertisement data including a content posted on a sign present within a predetermined range centered on the vehicle in a direction in which the display is installed, the predetermined range being identified based on the position information of the vehicle and map information, to the in-vehicle apparatus via the communicator.

5. A vehicle-directed advertisement information distribution method, the method comprising:
receiving position information of a vehicle in which a display is installed so as to face an inside of the vehicle, from an in-vehicle apparatus included in the vehicle, the in-vehicle apparatus being configured to perform processing for display on the display; and
transmitting advertisement data including a content posted on a sign present within a predetermined range centered on the vehicle in a direction in which the display is installed, the predetermined range being identified based on the position information of the vehicle and map information, to the in-vehicle apparatus via the communicator.
